(19) United States
(12) Patent Application Publication
(10) Pub. No.: US 2024/0423181 A1
(43) Pub. Date: Dec. 26, 2024

(54) Non-painted Fake Bait Structure

(71) Applicant: Ever Grass International Co., LTD., Hemei Township (TW)

(72) Inventor: Tsung-Hsi Tsai, Hemei Township (TW)

(21) Appl. No.: 18/337,536

(22) Filed: Jun. 20, 2023

(51) Int. Cl. A01K 85/01

(52) U.S. Cl. CPC A01K 85/012

(57) ABSTRACT

A non-painted fake bait structure contains a body and a light-reflective counterweight. The body includes a first casing and a second casing which are symmetrical, and the body also includes a head, an extension, a tail, and a fish hook. The body includes a receiving groove defined therein and a diamond-shaped pattern formed on the receiving groove. The light-reflective counterweight is accommodated in the receiving groove of the body, and the light-reflective counterweight includes multiple counterweight protrusions mounted therein. In addition, the light-reflective counterweight includes a laser reflecting stick adhered thereon. A spaced distance is defined between the laser reflecting stick of the light-reflective counterweight and the diamond-shaped pattern, such that the laser reflecting stick absorbs lights to reflect refracted lights on the diamond-shaped pattern of the body, thus forming reflection as fish scales to attract fishes to bite the non-painted fake bait structure.

### TECHNICAL FIELD

The present invention relates to a fake bait structure, and more particularly to a non-painted fake bait structure which produces natural lights to attract fishes to bite the non-painted fake bait structure.

### BACKGROUND

As the government withdrawn the restrictions on offshore fishing, the sea fishing industry has been showing a vigorous development. The TV media have also begun to produce and broadcast some videos about sea fishing skills. So, it can be seen that sea fishing activities are welcomed by quite a few people. However whether it is sea fishing, river fishing or stream fishing, the biggest difference should be the difference in baits.

Because fish have the habit that big will fish eat small fish, many manufacturers have designed fake baits of different shapes and sizes to attract fish to bite baits. However, fish have phototaxis, many manufacturers will spray luminous paint inside the bait, or bake varnish inside the bait, and use the lights (brightness) generated by the aforementioned luminous paint to attract fish to bite the baits.

But, most fake lures do not have a natural glow. In other words, it cannot show the reflective effect like fish scales, so sometimes the fish catch is not good. For this reason, some manufacturers put laser reflective stickers inside the fake bait, but there is also a counterweight inside the fake bait. The track not only presents a more complicated appearance, but also is not easy to adhere laser reflective stickers. After cutting with a special knife die, it must avoid the track of the fake bait, thus causing difficult production and high fabrication cost.

The present invention has arisen to mitigate and/or obviate the afore-described disadvantages.

### SUMMARY

The primary aspect of the present invention is to provide a non-painted fake bait structure which achieves easy production and outstanding light reflection as fish scales.

To obtain above-mentioned aspect, a non-painted fake bait structure provided by the present invention contains: a body and a light-reflective counterweight. The body includes a first casing and a second casing which are symmetrical, and the body also includes a head, an extension, a tail, and a fish hook. Furthermore, the body includes a receiving groove defined therein and a diamond-shaped pattern formed on the receiving groove. The light-reflective counterweight is accommodated in the receiving groove of the body, and the light-reflective counterweight includes multiple counterweight protrusions mounted therein. The light-reflective counterweight includes a laser reflecting stick adhered thereon. A spaced distance is defined between the laser reflecting stick of the light-reflective counterweight and the diamond-shaped pattern, such that the laser reflecting stick absorbs lights to reflect refracted lights on the diamond-shaped pattern of the body, thus forming reflection as fish scales to attract fishes to bite the non-painted fake bait structure.

Thereby, the non-painted fake bait structure of the present invention has advantages as follows:
1) The laser reflecting stick absorbs the lights to reflect the refracted lights on the diamond-shaped pattern of the body so that the non-painted fake bait structure swims in the water lifelikely, thus forming reflection as the fish scales to attract fishes to bite the non-painted fake bait structure.
2) The refracted lights produce on the body in a fish shape to attract more fishes to bite the non-painted fake bait structure effectively.
3) The non-painted fake bait structure is produced easily, for example, the body and the light-reflective counterweight are made by at least one plastic injection mold, and the laser reflecting stick is adhered on the light-reflective counterweight, then the body is connected with the light-reflective counterweight, thereby obtaining easy assembly, efficient production, and low fabrication cost.

### BRIEF DESCRIPTION OF THE DRAWINGS

FIG. 1 is a perspective view showing the assembly of a non-painted fake bait structure according to a preferred embodiment of the present invention.

FIG. 2 is a perspective view showing the exploded components of the non-painted fake bait structure according to the preferred embodiment of the present invention.

FIG. 3 is a side plan view showing the assembly of a part of the non-painted fake bait structure according to the preferred embodiment of the present invention.

FIG. 4 is a cross sectional view showing the assembly of the non-painted fake bait structure according to the preferred embodiment of the present invention.

FIG. 5 is a schematic view showing the assembly of the non-painted fake bait structure according to the preferred embodiment of the present invention.

FIG. 6 is a schematic view showing the assembly of a part of the non-painted fake bait structure according to the preferred embodiment of the present invention.

FIG. 7 is another schematic view showing the assembly of a part of the non-painted fake bait structure according to the preferred embodiment of the present invention.

### DETAILED DESCRIPTION

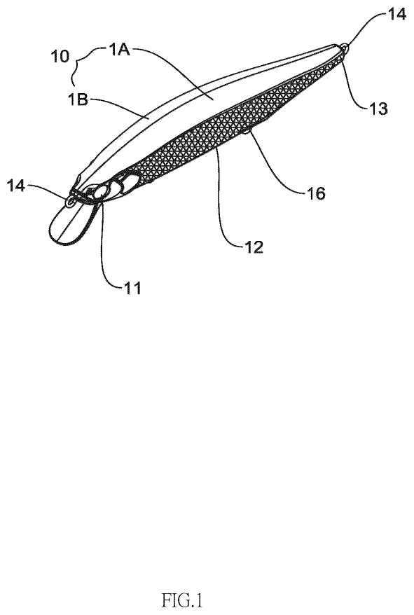

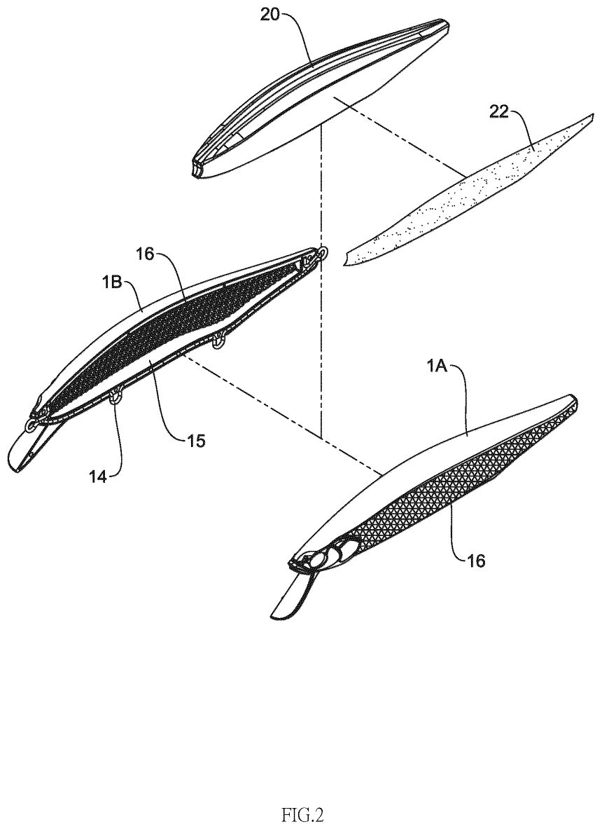

With reference to FIGS. 1-2, a non-painted fake bait structure according to a preferred embodiment of the present invention comprises: a body 10 and a light-reflective counterweight 20.

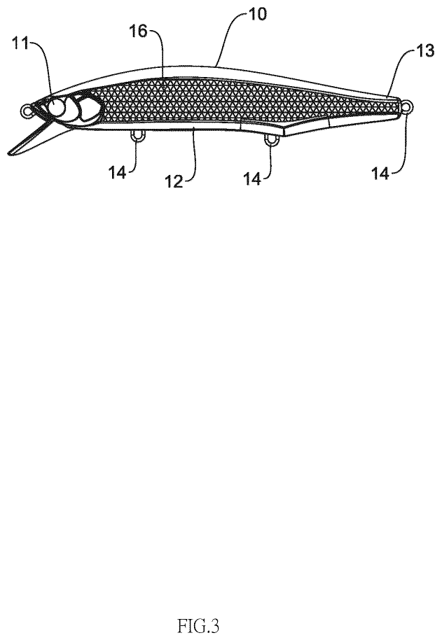

Referring to FIGS. 1-3, the body 10 includes a first casing 1A and a second casing 1B which are symmetrical, and the body 10 also includes a head 11, an extension 12, a tail 13, and a fish hook 14 fixed at a predetermined position of the body 10.

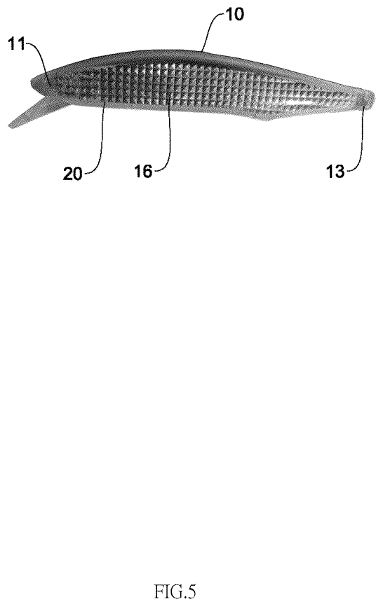

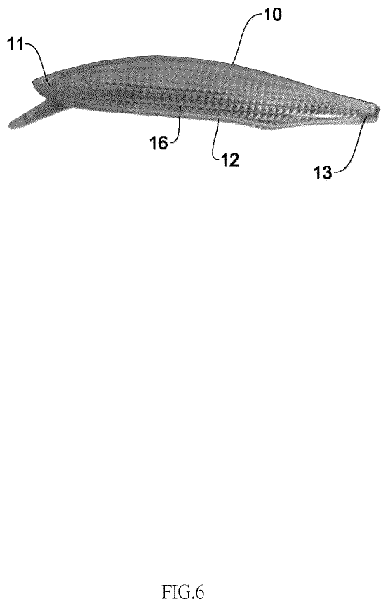

As shown in FIGS. 2, 3, 5 and 6, the body 10 further includes a receiving groove 15 defined therein and a diamond-shaped pattern 16 formed on the receiving groove 15.

The first casing 1A is connected with the second casing 1B by using a slot and a tenon received in the slot. Alternatively, the first casing 1A is connected with the second casing 1B by using an adhesive. Furthermore, the body 10 is made of plastic material and is transparent or translucent.

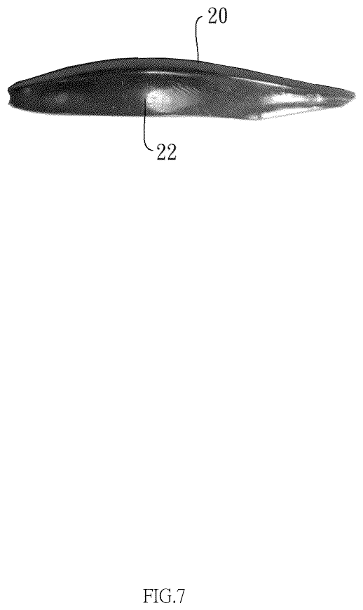

As illustrated in FIGS. 1-2, 4-5 and 7, the light-reflective counterweight 20 is accommodated in the receiving groove 15 of the body 10. The light-reflective counterweight 20 includes multiple counterweight protrusions 21 mounted therein, and the light-reflective counterweight 20 includes a laser reflecting stick 22 adhered thereon, wherein a spaced distance D is defined between the laser reflecting stick 22 of the light-reflective counterweight 20 and the diamond-shaped pattern 16, such that the laser reflecting stick 22 absorbs lights to reflect refracted lights on the diamond-shaped pattern 16 of the body 10, thus forming reflection as fish scales to attract fishes to bite the non-painted fake bait structure.

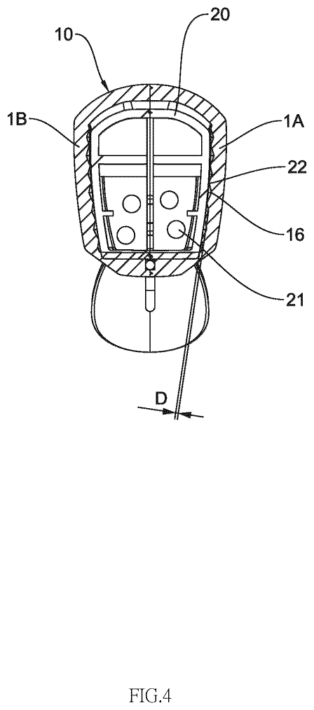

With reference to FIG. 4, the multiple counterweight protrusions 21 move in the light-reflective counterweight 20 to actuate the body 10 to swim in water as the fishes.

Accordingly, the non-painted fake bait structure of the present invention has advantages as follows:
1) The laser reflecting stick 22 absorbs the lights to reflect the refracted lights on the diamond-shaped pattern 16 of the body 10 so that the non-painted fake bait structure swims in the water lifelikely, thus forming the reflection as the fish scales to attract fishes to bite the non-painted fake bait structure.
2) The refracted lights produce on the body 10 in a fish shape to attract more fishes to bite the non-painted fake bait structure effectively.
3) The non-painted fake bait structure is produced easily, for example, the body 10 and the light-reflective counterweight 20 are made by at least one plastic injection mold, and the laser reflecting stick 22 is adhered on the light-reflective counterweight 20, then the body 10 is connected with the light-reflective counterweight 20, thus obtaining easy assembly, efficient production, and low fabrication cost.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A non-painted fake bait structure comprising:
a body including a first casing and a second casing which are symmetrical, and the body also including a head, an extension, a tail, and a fish hook fixed at a predetermined position of the body;
wherein the body further includes a receiving groove defined therein and a diamond-shaped pattern formed on the receiving groove;
wherein a light-reflective counterweight is accommodated in the receiving groove of the body, the light-reflective counterweight includes multiple counterweight protrusions mounted therein, and the light-reflective counterweight includes a laser reflecting stick adhered thereon, wherein a spaced distance is defined between the laser reflecting stick of the light-reflective counterweight and the diamond-shaped pattern, such that the laser reflecting stick absorbs lights to reflect refracted lights on the diamond-shaped pattern of the body, thus forming reflection as fish scales to attract fishes to bite the non-painted fake bait structure.

2. The non-painted fake bait structure as claimed in claim 1, wherein the multiple counterweight protrusions move in the light-reflective counterweight.

3. The non-painted fake bait structure as claimed in claim 1, wherein the body is made of plastic material and is transparent or translucent.
